(19) United States
(12) Patent Application Publication
(10) Pub. No.: US 2020/0371999 A1
(43) Pub. Date: Nov. 26, 2020

(54) SYSTEM AND COMPUTER PROGRAM FOR PROVIDING AUTOMATED ACTIONS AND CONTENT TO ONE OR MORE WEB PAGES RELATING TO THE IMPROVED MANAGEMENT OF A VALUE CHAIN NETWORK

(71) Applicant: One Network Enterprises, Inc., Dallas, TX (US)

(72) Inventors: Ranjit Notani, Plano, TX (US); Yogesh Sharma, Frisco, TX (US)

(73) Assignee: One Network Enterprises, Inc., Dallas, TX (US)

(21) Appl. No.: 16/417,562

(22) Filed: May 20, 2019

(51) Int. Cl. G06F 16/176; G06F 16/958; G06F 16/957; H04L 29/08; G06Q 30/02

(52) U.S. Cl. CPC G06F 16/176; G06F 16/958; G06Q 30/0202; H04L 67/02; H04L 67/1097; G06F 16/9574

(57) ABSTRACT

A system, computer program product and system for providing automated actions and content to one or more web pages relating to the management of a value chain network. The value chain network includes a shared database on a computer over a network. The computer program product includes identifying an event in a value chain network, calculating a target value and a projected lost value, calculating a potential impact on a related performance target associated with the event, receiving one or more actions to resolve the event in the value chain network from one or more remote computers operated by respective one or more users, calculating a recovered value, calculating the difference between the target value and the recovered value, comparing the difference between the target value and the recovered value and historical differences stored in a database, storing the difference between the target value and the recovered value when the difference is less the respective historical differences stored in the database, retrieving the respective historical differences stored in the database, and transmitting one or more web pages containing the target value, recovered value and respective historical differences to a computer display. The target value is the anticipated value if the event in the value chain network had not occurred and the projected lost value is the anticipated lost value due to the event in the value chain network. The recovered value is the anticipated recovered value less the cost associated with each of the one or more actions to resolve the event in the value chain.

### BACKGROUND OF THE INVENTION

### Field of the Invention

The present invention is generally related to enterprise value chains, and more particularly to a system and computer program for providing automated actions and content to one or more web pages relating to the improved management of a value chain network.

### Discussion of the Background

Work within an enterprise or company is frequently performed within the framework, where one or more actions are required for such work and/or to resolve outstanding issues. Frequently as part of the business process, one or more users interact with each other to perform and/or initiate such actions. Such actions resulted in an outcome which may or may not have been the most desirable. This is due in part because the most desirable outcome sometimes result from one or more unexpected actions. However, historical information relating to desirable outcomes in relation to targets, and in relation to the actions and people involved is typically not maintained within the value chain. Systems known in the prior art have been incapable of capturing and linking new—or unexpected actions that may or may-not have a positive impact on the outcome—and using this information to drive continuous process improvement. There are also actions that may have previously happened outside the system that are now captured and added to social-process-graph (prescribed people/actions). As such, new actions for similar business problems are typically chosen rather than repeating the most desirable outcome, prioritized depending on the relative success-rate of the actions on the outcome.

Frequently as part of the business process, actions require one or more users perform certain repetitive activities, such as user clicks and providing certain content, on one or more web pages. Some known activities may be preferred by the user because of their desired outcome. Nonetheless, in the prior art, the user had no way of reducing the manual labor associated with performing the activities associated with these activities.

Thus, there currently exist deficiencies associated with enterprise value chain logistics planning, and, in particular, with providing automated actions and content in a value chain network.

### SUMMARY OF THE INVENTION

Accordingly, one aspect of the present invention is to provide a computer program product embodied on a non-transitory computer readable medium for providing automated actions and content to one or more web pages relating to the improved management of a value chain network. The value chain network includes a shared database on a computer over a network. The computer program is implemented by one or more processors executing processor instructions. The computer program product includes (i) a first computer code for identifying an event in a value chain network, (ii) a second computer code for calculating a target value and a projected lost value in relation to an established target, (iii) a third computer code for calculating a potential impact on a related performance target associated with the event, (iv) a fourth computer code for receiving one or more actions to resolve the event in the value chain network from one or more remote computers operated by respective one or more users, (iv) a fifth computer code for calculating a recovered value, (v) a sixth computer code for calculating the difference between the target value and the recovered value, (vi) a seventh computer code for comparing the difference between the target value and the recovered value and historical differences stored in a database, (vii) an eighth computer code for storing the difference between the target value and the recovered value when the difference is less the respective historical differences stored in the database, (viii) a ninth computer code for retrieving the respective historical differences stored in the database, and a (x) tenth computer code for transmitting one or more web pages containing the target value, recovered value and respective historical differences to a computer display. The target value is the anticipated value if the event in the value chain network had not occurred and the projected lost value is the anticipated lost value due to the event in the value chain network. The recovered value is the anticipated recovered value less the cost associated with each of the one or more actions to resolve the event in the value chain.

Another aspect of the present invention is to provide a system for providing automated actions and content to one or more web pages relating to the improved management of a value chain network. The system includes a plurality of remote computers, a central server, a network interface in communication with the central server and the plurality of remote computers over a network, and a shared database in communication with the central server. The network interface is configured to receive one or more transactions via the network, wherein the value chain network includes a plurality of local networks having shared access to two or more shared databases on a service provider computer over a network via a database router module. The central server is configured to (i) identify an event in a value chain network, (ii) calculate a target value and a projected lost value in relation to an established target, (iii) calculate a potential impact on a related performance target associated with the event, (iv) receive one or more actions to resolve the event in the value chain network from one or more remote computers operated by respective one or more users, (v) calculate a recovered value, wherein the recovered value is the anticipated recovered value less the cost associated with each of the one or more actions to resolve the event in the value chain, (vi) calculate the difference between the target value and the recovered value, (vii) compare the difference between the target value and the recovered value and historical differences stored in a database, (viii) store the difference between the target value and the recovered value when the difference is less the respective historical differences stored in the database, (ix) retrieve the respective historical differences stored in the database, and (x) transmit one or more web pages containing the target value, recovered value and respective historical differences to a computer display. The target value is the anticipated value if the event in the value chain network had not occurred and the projected lost value is the anticipated lost value due to the event in the value chain network.

Yet another aspect of the present invention is to provide a computer program product embodied on a non-transitory computer readable medium for providing automated actions and content to one or more web pages relating to the improved management of a value chain network. The value chain network includes a shared database on a computer over a network. The computer program is implemented by one or more processors executing processor instructions. The computer program product includes: (i) a first computer code for identifying and capturing a macro derivation having a set of activities in a value chain network, (ii) a second computer code for calculating an accuracy value for the macro derivation, (iii) a third computer code for storing the macro derivation and accuracy value for the macro derivation, (iv) a fourth computer code for retrieving a macro derivation recommendation for the one or more web pages based on similarities between the currently required macro derivation and the stored macro derivation and the accuracy value of the macro derivation recommendation, (v) a fifth computer code for providing a macro derivation recommendation to the user which may be accepted or rejected by the user, (vi) a sixth computer code for storing a refined accuracy value for the macro derivation, and (vii) a seventh computer code for executing the macro derivation recommendation upon acceptance by the user on one or more web pages to a computer display. The set of activities includes one or more user clicks on one or more web pages. Calculating the accuracy value for the macro derivation recommendation includes refining accuracy value positively or negatively based on the respective acceptance or rejection of the macro derivation recommendation.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1A-1D are block diagrams illustrating an exemplary system and computer program for improved processing in a value chain network in accordance with an embodiment of the present invention;

FIGS. 2A-2B are flow charts illustrating a method for improved processing in a value chain network in accordance with an embodiment of the present invention;

FIG. 2C is a flow chart illustrating a method for providing automated actions and content to one or more web pages relating to a value chain network in accordance with an embodiment of the present invention; and

FIGS. 3A-3L illustrate exemplary user interfaces of an exemplary computer-based system for improved processing in a value chain network in accordance with an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

The present invention provides a computer program and method for performing intelligent, content-based indexing, searching, retrieval, analysis, processing of data, and decision-making for improved processing in a value chain network based on the data contained in the database, as described herein. The present invention, without limitation, captures and measures the impact of actions and people on the performance outcomes. Such performance outcomes includes without limitation cost, recovered sales, effect on key performance indicators, as used herein “KPI”, including without limitation service levels and financial indicators, in relation to a known business value opportunity type. The present invention provides the ability to manually or automatically, using pre-defined and configurable rules stored in database, continuously improve a process map—which should result in incremental improvement on the related performance targets and KPIs.

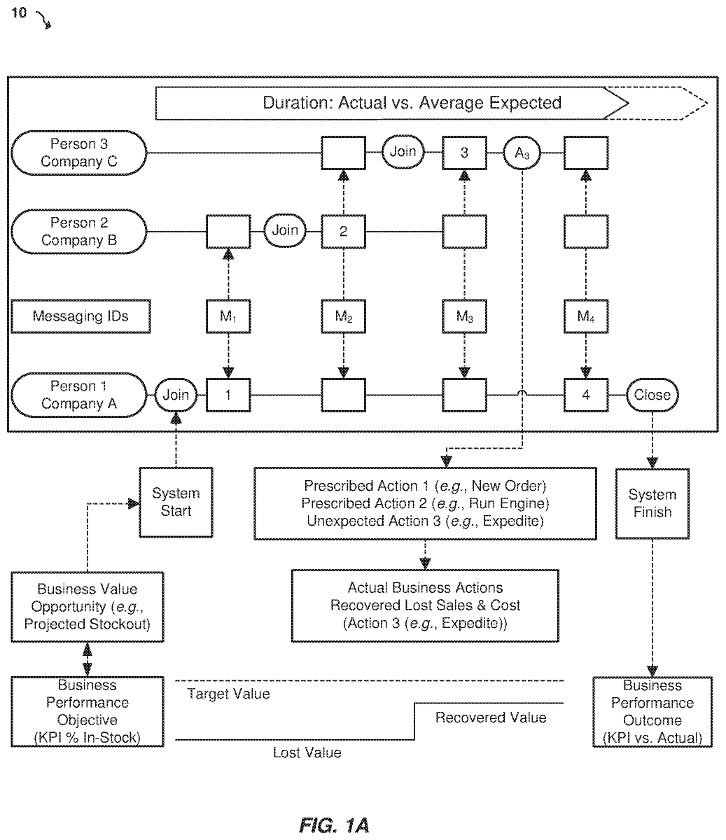

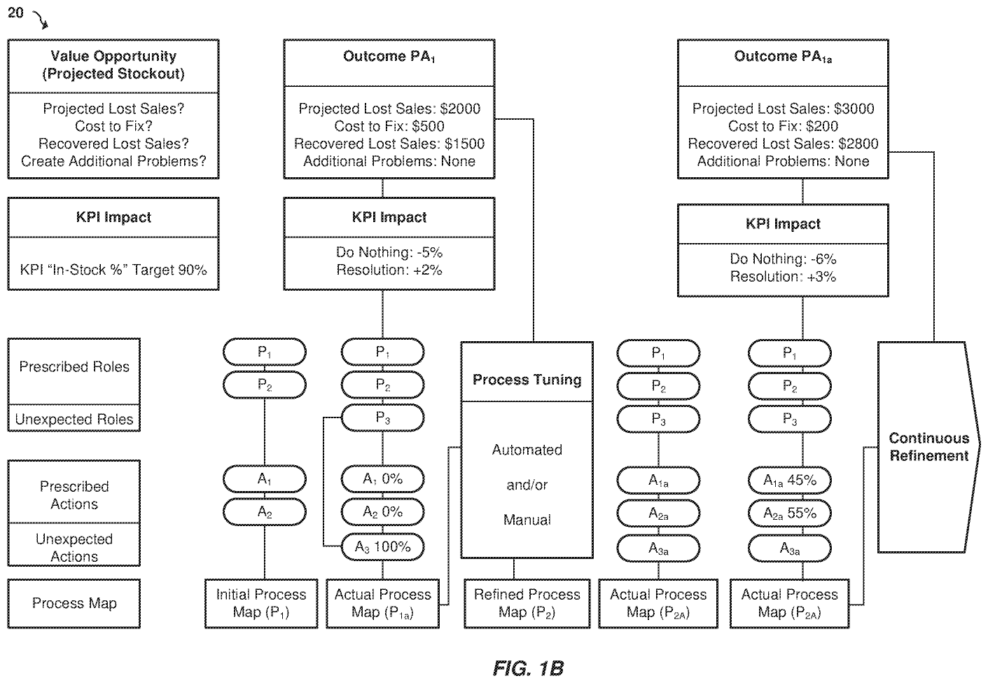

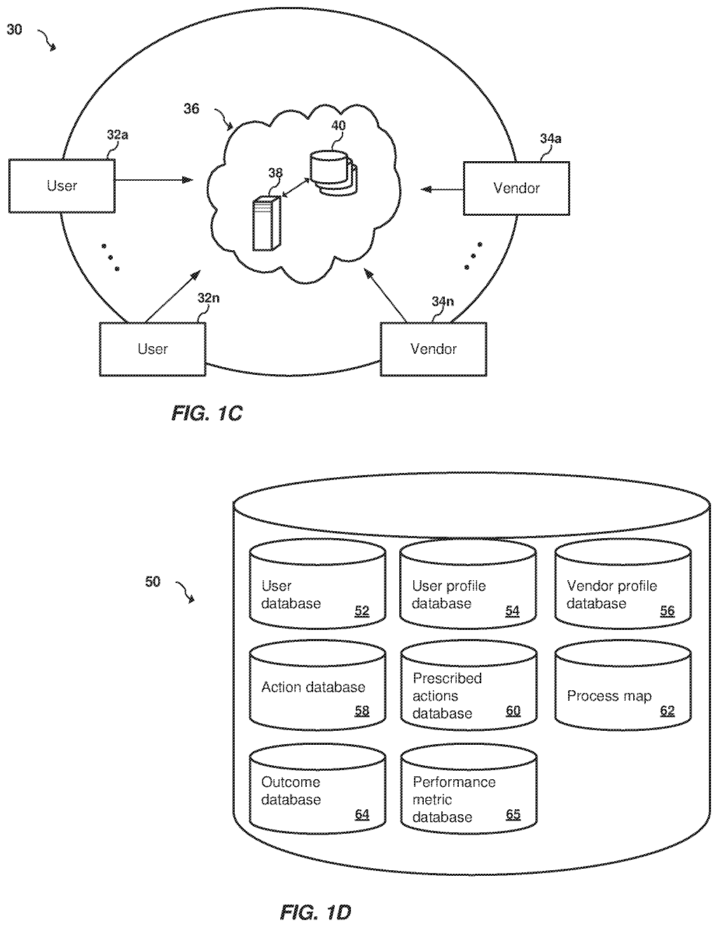

Referring to FIGS. 1A-1D, block diagrams illustrating an exemplary system and computer program for improved processing in a value chain network in accordance with an embodiment of the present invention are shown. As shown in FIG. 1D, the present invention includes, without limitation, user database 52, user profile database 54, vendor profile database 56, action database 58, prescribed action database 60, process map 62, outcome database 64, and performance metric database 65. Performance metric database 65 is used to store the desired target values and KPIs in relation to an event. The present invention creates a “social-process graph”, utilizing, without limitation, user database 52, action database 59 and outcome dataset 64, to connect people, actions, and outcomes to business value opportunities and performance objectives.

According the present invention, there exists known prescribed actions and possible actions associated with an event in a value chain. For instance, the event might be without limitation, a projected stockout event, the prescribed actions to the projected stockout might be either generating a new order or to re-allocate inventory, and the action might be expedited shipment.

According to the example shown in FIGS. 1A-1B, identified as 10 and 20 respectively, an event (e.g., a projected stockout) is identified by the present system. The event has a projected lost value (e.g., the value of the anticipated loss of sales) that is determined by the present invention. The projected lost value may be determined, without limitation, by extracting historical information from one or more databases 40. If, for instance, the projected lost value to be calculated is due to a projected stockout, then the projected lost value may, without limitation, be calculated as the average daily sales, extracted from one or more databases 40, multiplied by the number of days before the inventory is scheduled to be replenished. This information may be transmitted to a computer display visible by a user via one or more user graphical user interfaces.

Person₁, using the present invention, initiates a communication thread to address the event using the system of the present invention. A first communication (M₁) identifying the event (e.g., the projected stockout event) is exchanged from person₁ to person₂ using the system of the present invention. In response, person₂ joins the communication thread. Person₃ is identified as a person who may be able to help resolve the event. This may be, for instance, because Person₃ is identified either manually or automatically by the present invention as someone who has participated in a same or similar activity before, has “followed” the particular event/BVO type, or has “followed” a customer, product or location that is involved in the event.

A second communication (M₂) is then exchanged from person₂ to person₁ and person₃ using the system of the present invention. In response, person₃ joins the communication thread. An action (A₁) is proposed to resolve the projected stockout. A third communication (M₂) is then exchanged from person₃ to person₁ and person₂ using the system of the present invention. In this example, the action (A₁) is to pay for expedited shipping to have the projected stockout item shipped before the projected stockout event occurs.

The action (A₁) is captured by the system of the present invention. The action (A₁) may be automatically captured by the present invention in numerous ways including, without limitation, parsing the communication for tags, XML data, keywords, identifiers and/or communication subject which suggest an action, or may be read from pre-defined pull down menus displayed on a computer display using a graphical user interface which may be pre-defined and/or configurable by the user. In an alternate embodiment, the action (A₁) may be manually entered using a graphical user interface provided by the present invention.

The target value (e.g., the anticipated sales if there was no projected stockout event), is initially the projected loss, is then compared against the projected lost value (e.g., the value associated with the anticipated loss of sales) plus the recovered value as a result of business actions (e.g., the value of the anticipated sales after the expedited shipment less the cost to expedite the shipment) to capture a percentage gain or loss.

The prescribed actions database 60 is searched for one or more previously known matching actions based on search criteria including, without limitation, tags, XML data, keywords, or other identifiers and/or a communication subject. Each prescribed actions database 60 entry has an associated one or more entries in the outcome result database 64. The outcome result database 64 may include, without limitation, a target value, a projected lost value and/or a recovered value. If any previously known matching actions are found in the prescribed actions database 60, then the system of the present invention compares the recovered value against the associated values in the outcome result database 64. If the difference between the target value and the recovered value is less than any previously known actions, then the action (A₁) and its associated recovered value are automatically stored in the prescribed action database 60 and the outcome result database 64.

If the difference related to the action is more than any previously known actions, this action is also automatically stored the prescribed action database 60 and the outcome result database 64 in order to avoid such an action in the future by adjusting a policy to not perform that particular action again. The calculation of the cost versus the value, displayed on a computer display using a graphical user interface should also provide an indication to the user. For instance, the user shouldn't “commit” the change, if the cost exceeds the projected recovered sales value. According to one embodiment, the multiple possible actions (and people involved) to resolve the unexpected event are be stored in the prescribed action database 60 in order of the greatest financial savings.

The present invention also provides a computer program and method for providing automated actions and content to one or more web pages based on recommended known macro derivations. According to this embodiment, web page activities, referred to herein as macro derivations, including without limitation as user clicks, content and server responses, are stored in the database 50. If any previously known matching actions are found in the prescribed actions database 60, then the system of the present invention may recommend one or more previously stored macro derivations to the user. The user may accept or reject the macro derivation recommendations. If the user accepts a macro derivation recommendation, then the system executes the macro derivation on the one or more web pages with minimal or no user input. The system also learns and forms an accuracy percentage for the macro derivation recommendations based on the user's acceptance or rejection of the macro derivation recommendation. The system suggests macro derivation recommendations in the future based on the adjusted accuracy percentage of the macro derivation recommendation. The system may also be configured to automatically execute a macro derivation recommendation if the macro derivation recommendation has an accuracy percentage above a configurable threshold.

As a non-limiting example, assume a first web page includes N records, each having actions A1 and A2, and a second web page includes N records, each having actions A3 and A4. For each of the N records, the first user typically invokes actions A3 and A4 on the second web page. The first user sometimes invokes action A1 for some of the records on the first web page while another user sometimes invokes action A2 on the first web page. Yet another user may utilize a third or fourth web page and may typically invoke repetitive actions on any of those web page. Notably, each of the above scenarios involves the invocation of repetitive actions. The user does typically invokes similar macro derivations every day using the same web pages and taking the same actions.

In the above example, the interceptor module captures all of the records and sequence of clicks from the first web page and second web page along with actions A1-A4 in the database. For the repetitive sequence of flow, the extractor module determines the relationship between the rows of the first web page and the second web page, and determines when to invoke actions A1 and A2 by learning and utilizing certain rules. The recommendation module applies these rules for the new set of data and provides the user a single web page having all the necessary data elements grouped by actions. The user can review and invoke common actions on many rows with a single click without having to go to record by record and across multiple web pages. The accuracy module re-learns the macro derivation actions based on either long term consequences of these actions considering without limitation statistics, cost, revenue, price and the like, or similar actions by other users within or outside the value chain. The auto execution module based on a macro derivation's accuracy or configuration takes certain actions automatically without user intervention.

### Processing Flows

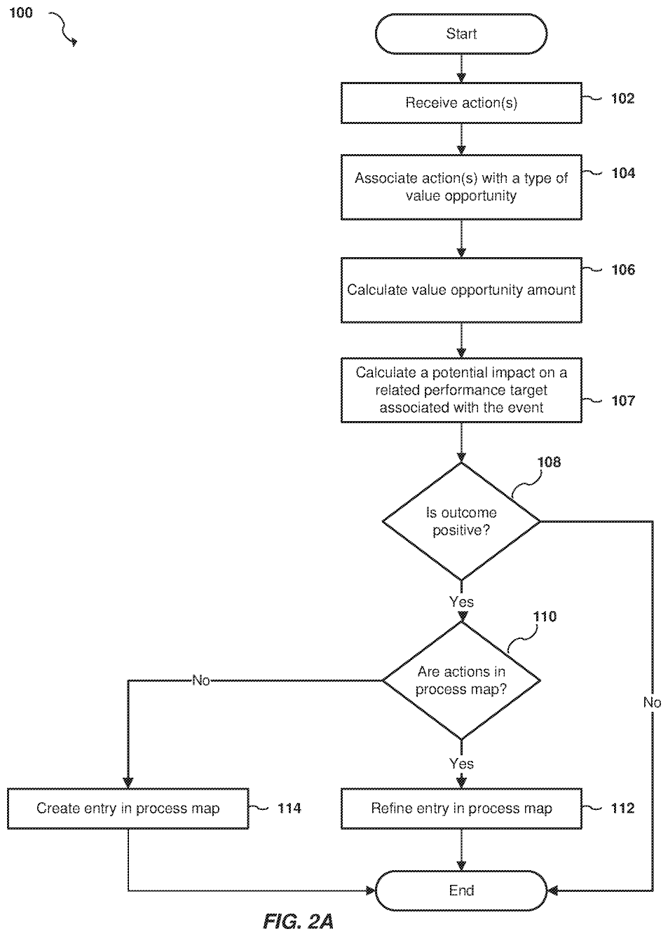

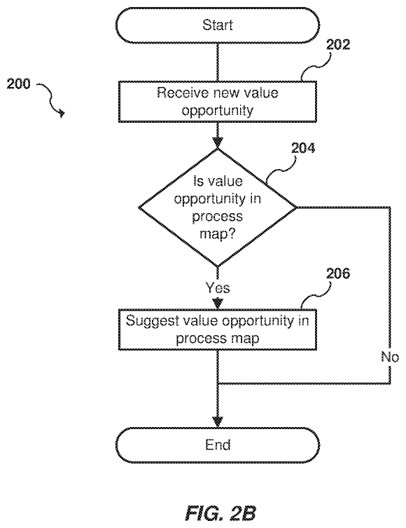

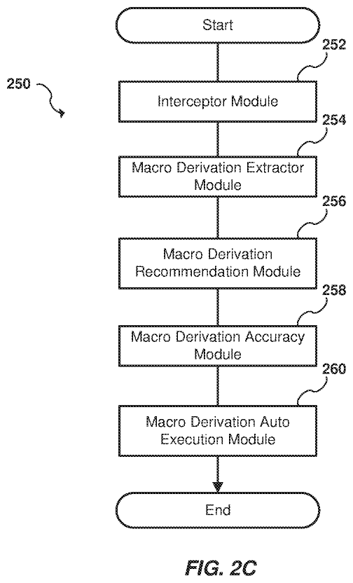

Referring to FIG. 2A, a flow chart illustrating a method for improved processing in a value chain network in accordance with an embodiment of the present invention is shown. At block 102, one or more actions are received by the system of the present invention. These actions may be either automatically entered by the system, or manually entered by the user. The actions are associated with a particular type of opportunity, at block 104. At block 106, the opportunity amount is calculated. A potential impact on a related performance target associated with the event is calculated at block 107.

A determination is made as to whether the action resulted in a positive amount, at conditional block 108. If the action resulted in a non-positive amount then processing ends. However, in an alternate embodiment, negative results are also maintained in order to avoid a negative outcome in the future. If the action resulted in a positive amount, then processing continues, at block 110. At conditional block 110, a determination is made as to whether the received actions are already associated with the process map. If the actions are found in the process map, then the entry is optionally refined by the system in the process map at block 112. Otherwise, if the actions are not in the process map, then a new entry is created in the process map by the system, at block 114. According to an alternate embodiment, actions associated with multiple respective outcomes are stored in the process map and arranged by the respective recommendation's positive amount. There are prescribed actions and people (added by criteria mentioned above). For a given event (or business value opportunity), there is also an associated performance measure (value or KPI) that is globally set. For instance, the business value opportunity for a stock out is the projected lost sale/recovered lost sales (the monetary value). The time/responsiveness is optionally stored in the database. This is useful where time has an impact on the recovered lost sales (e.g., where a faster time is preferred over a slower time, as is often the case).

Optionally, the time of the event from when the activity was first engaged to when it is completed is stored in the database. This calculated time may be stored and later utilized where people and actions have the best value outcomes and where time or speed “responsiveness” is an important factor to realizing the outcome (e.g., waiting too late/long will also “miss” the opportunity).

Referring to FIG. 2B, a flow chart illustrating a method for improved processing in a value chain network in accordance with an embodiment of the present invention is shown. At block 202, a new opportunity is received. A determination is made as to whether the opportunity is in the process map, at conditional block 204. If the opportunity is found in the process map, then it is extracted from the process map and a recommendation is provided by the system of the previous solution that resulted in a positive result, at block 206. According to an alternate embodiment, multiple outcomes are stored in the process map and, likewise, multiple potential recommendations are offered which may be sorted by the respective recommendation's positive amount in a graphical user interface provided to the user.

Referring to FIG. 2C, a flow chart illustrating a method for providing automated actions and content to one or more web pages related to a value chain network in accordance with another embodiment of the present invention is shown. Block 252 represents the interceptor module. The interceptor module 252 monitors user 32a-32n activity, such as user clicks, and identifies the data elements that are visually presented to the user 32a-32n. The sequences of click-throughs are identified and recorded in the action database 58. The recorded data includes without limitation the user name, role and organization associated with the user click(s). The recorded data includes any server responses and user clicks and/or data entered on any elements transmitted by the server(s) and presented in a web page to the user 32a-32n. Such user clicks and/or data entered includes without limitation key and/or button clicks, search and/or navigation to look up different user interface artifacts. According to this embodiment, all user clicks and their sequence, data sent to the server, and any responses from the server are intercepted and recorded in action database 58.

Block 254 represents the macro derivation extractor module. The macro derivation extractor module 254 periodically data mines the action database 58 for each user to learn any patterns in one or more sequence of events using a statistical function. When identifying these patterns, the macro derivation extractor module 254 attempts to decipher the relationship between any existing sequence(s) and other related sequence which produces different end results. A data structure is used to hold the sequence of events that are similar and the mapping of different resulting actions. The macro derivation extractor module 254 identifies the decision-making elements which are resulting in different actions. Based on these sequences of events, decision making element, and actions, a statistically derived algorithm is utilized to extract a macro derivation which when invoked will replicate what the user 32a-32n is performing within a defined timeframe, such as without limitation, hourly, daily, weekly, monthly and/or annually.

Block 256 represents the macro derivation recommendation module. The macro derivation recommendation module 256 imposes any identified and validated macro derivations for a given user on a future set of data is presented to the user 32a-32n such that complex and potentially multiple-screen actions may be performed with minimal input from the user 32a-32n. For instance, the user 32a-32n may be provided via a dynamic user interface which only requires a single click from the user to perform complex and potentially multiple-screen actions. According to this embodiment, the dynamic user interface include all of the data required by the user 32a-32n for decision making. The user 32a-32n may accept or reject the recommended macro derivation. If the recommended macro derivation is rejected, then the macro derivation will not be automated and the user may manually enter such actions on the one or more screens. Alternatively, the macro derivation recommendation may be configured to be activated without prompting the user.

Block 258 represents the macro derivation accuracy module. The macro derivation accuracy module 258 stores the user's acceptance or rejection of macro derivation recommendations in the database 50. An accuracy percentage for a macro derivation recommendation is also stored in database 50. The accuracy percentage is determined based on the number of times the macro derivation recommendation is accepted or rejected by the user 32a-32n. According to this embodiment, macro derivation recommendations having an accuracy percentage above a configurable threshold for that user may be configured for auto execution. Rejected macro derivation recommendations may be re-processed by the macro derivation extractor module 254 with newer data to identify new patterns.

Block 260 represents the macro derivation auto execution module. The macro derivation auto execution module 260 provides the user 32a-32n with a user interface including without limitation macro derivation recommendations for the user and their respective accuracy percentages. A minimum accuracy threshold may be provided by the user 32a-32n. If the macro derivation recommendation is above this user-configurable minimum accuracy threshold, then the system will automatically execute the recommended macro derivation without requiring user intervention.

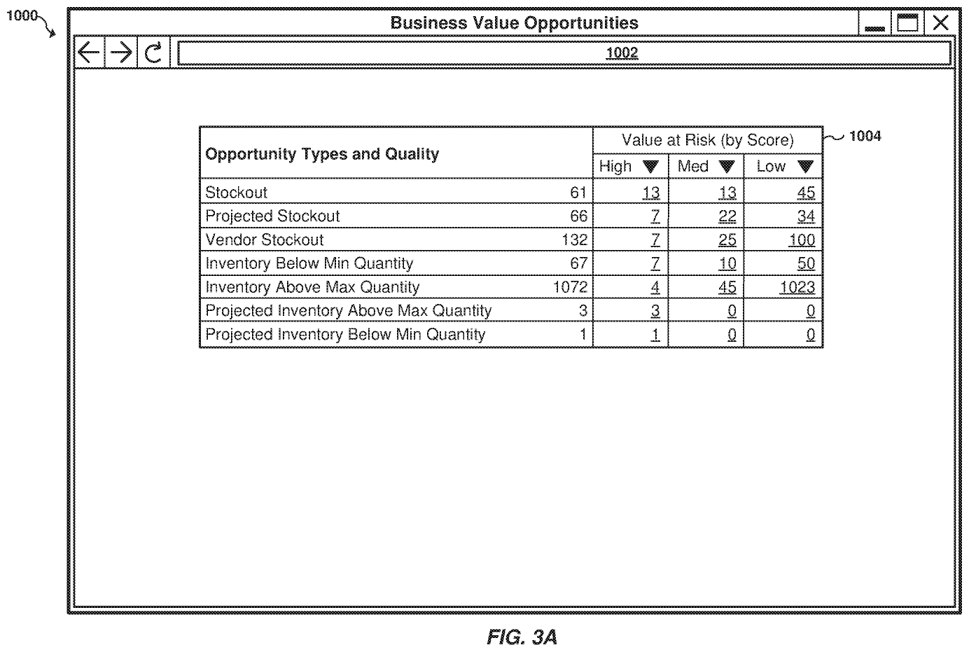

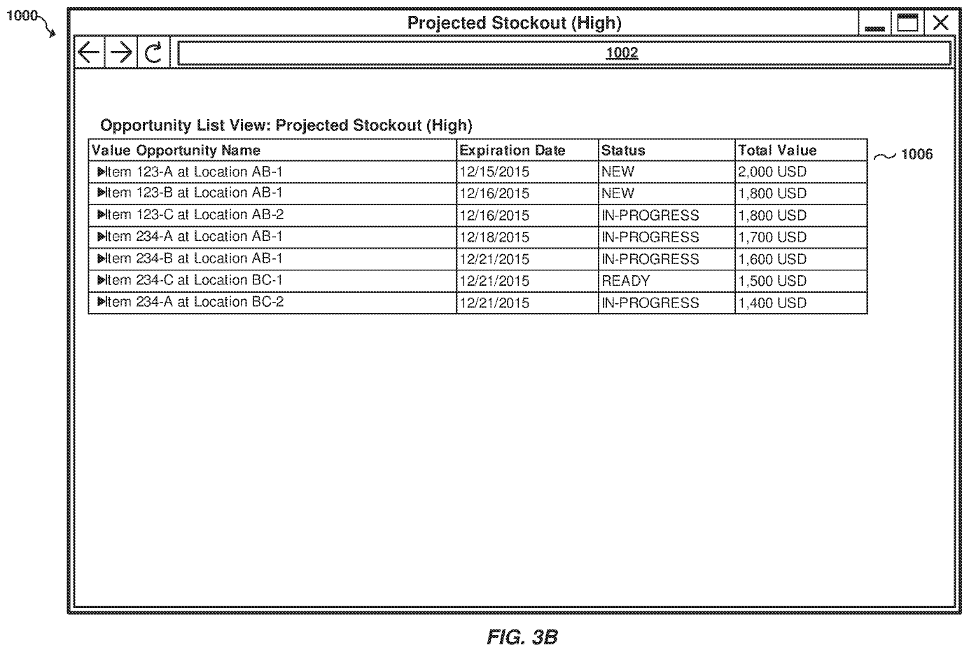

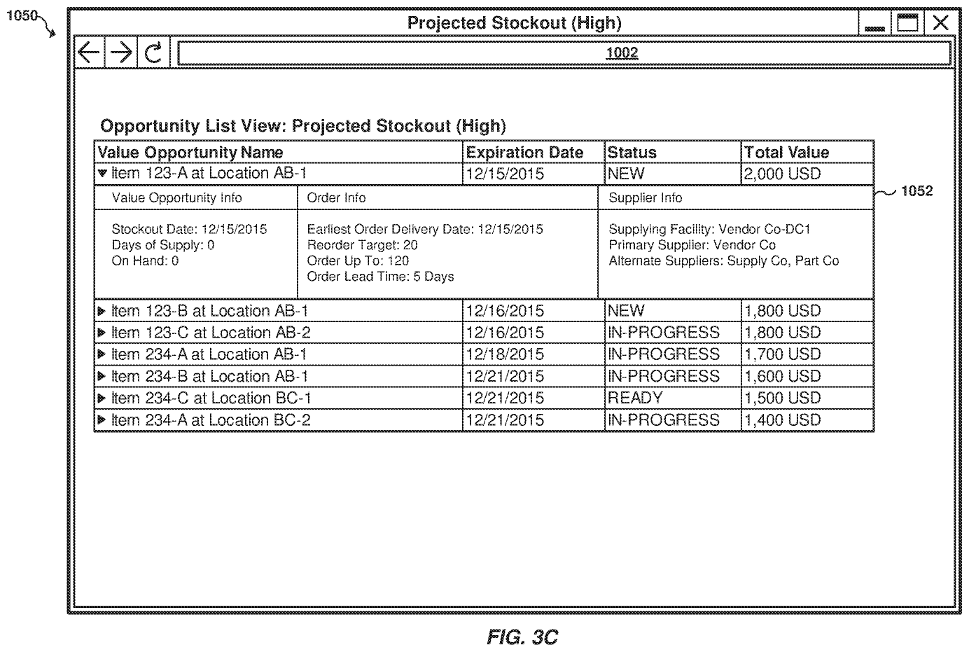

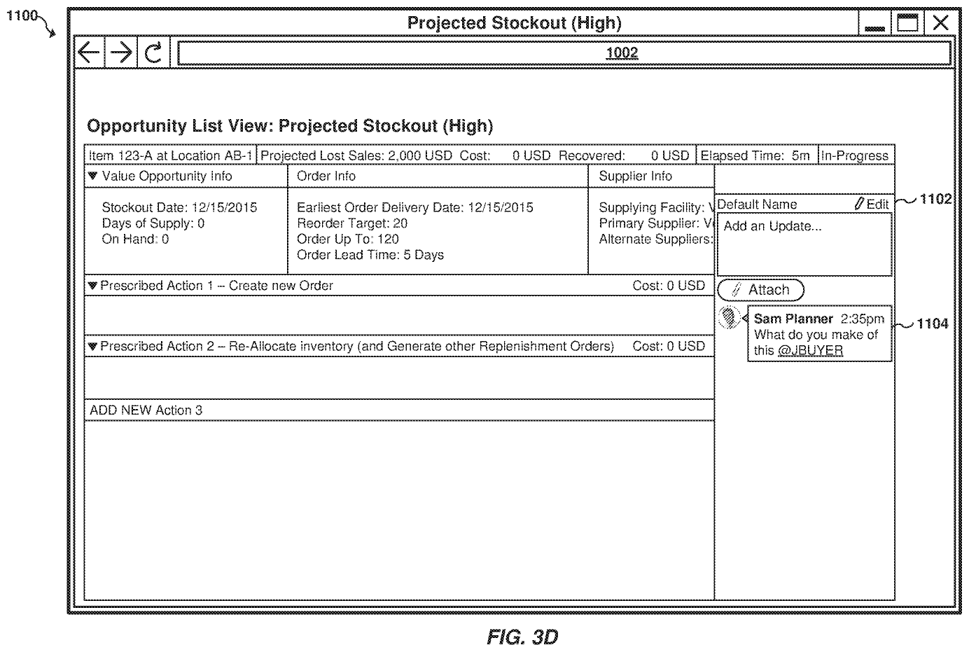

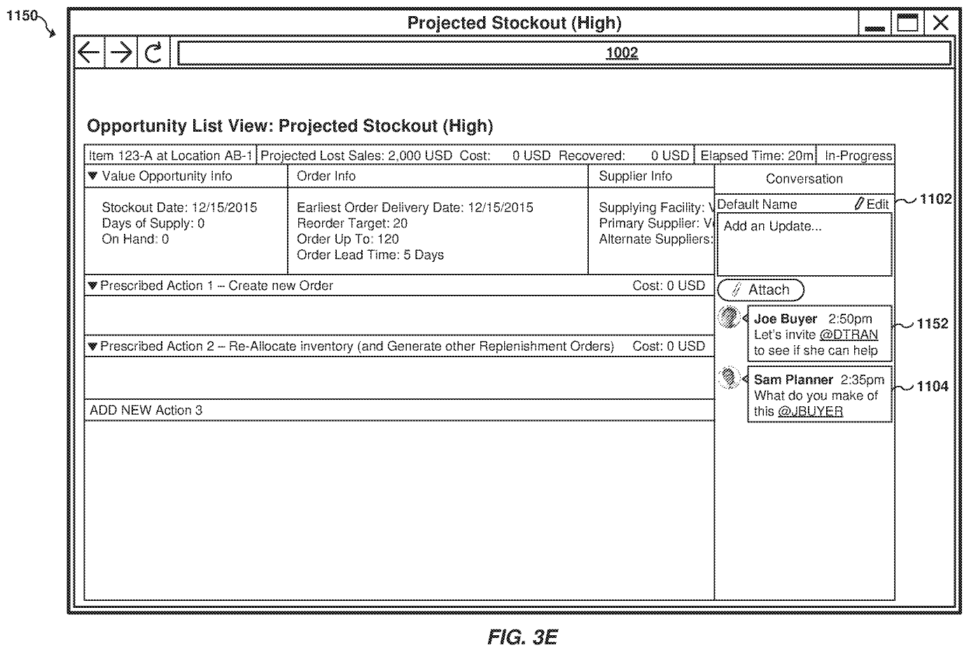

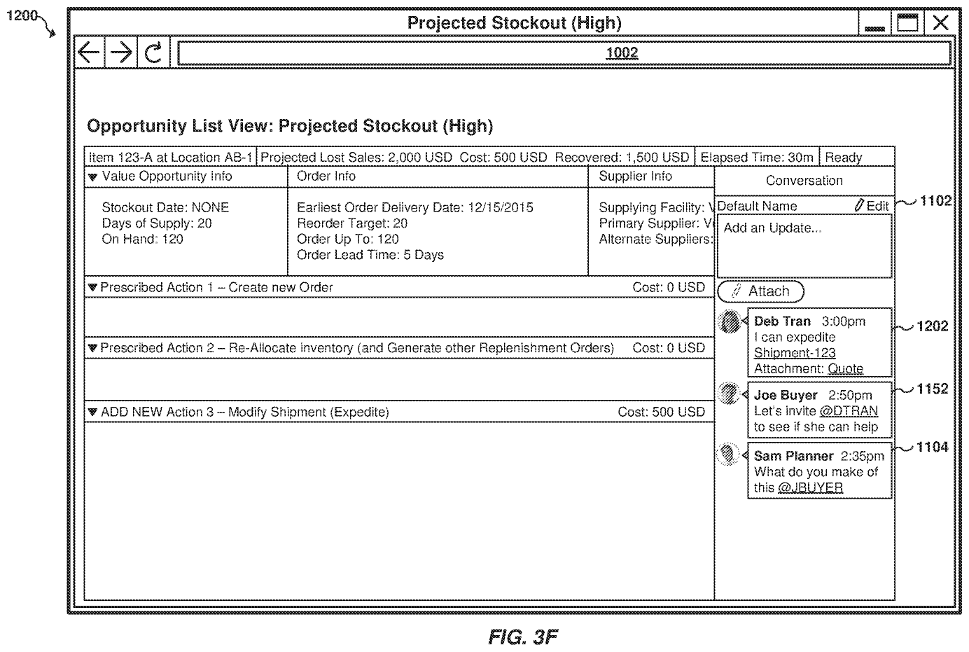

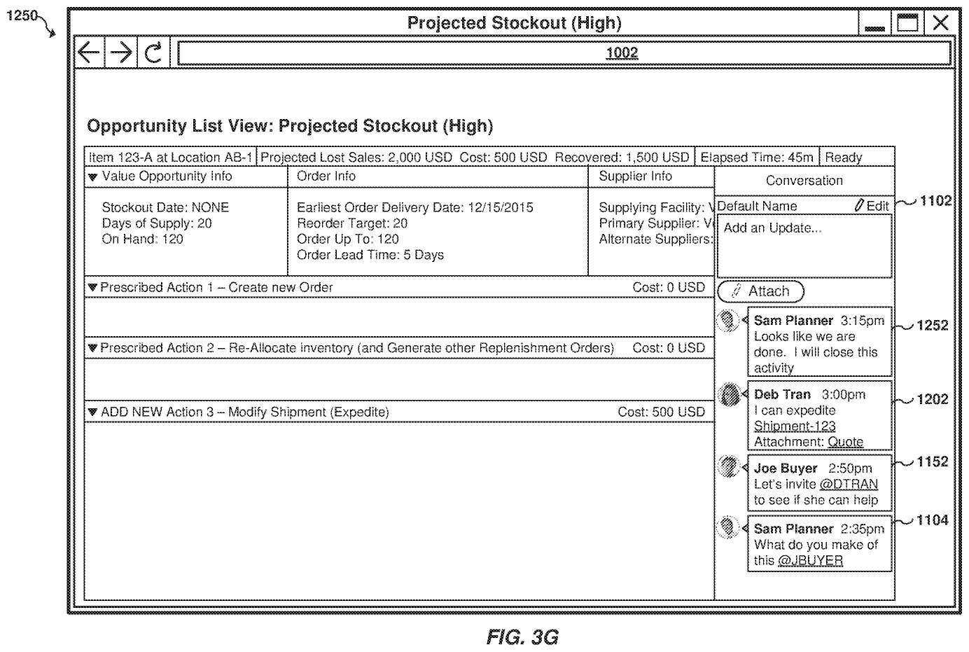

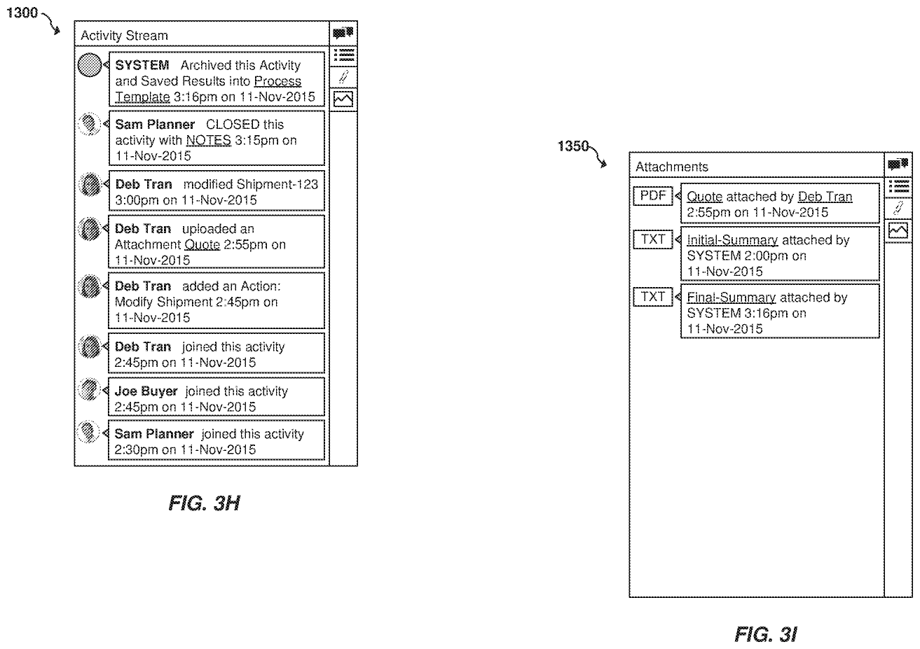

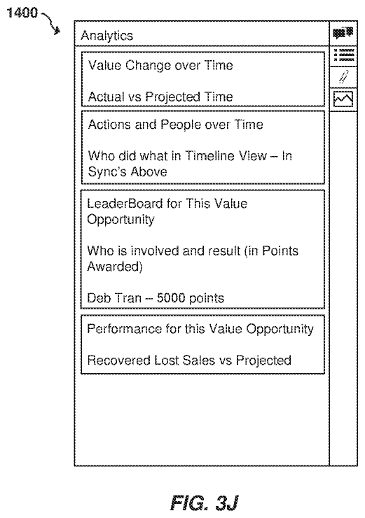

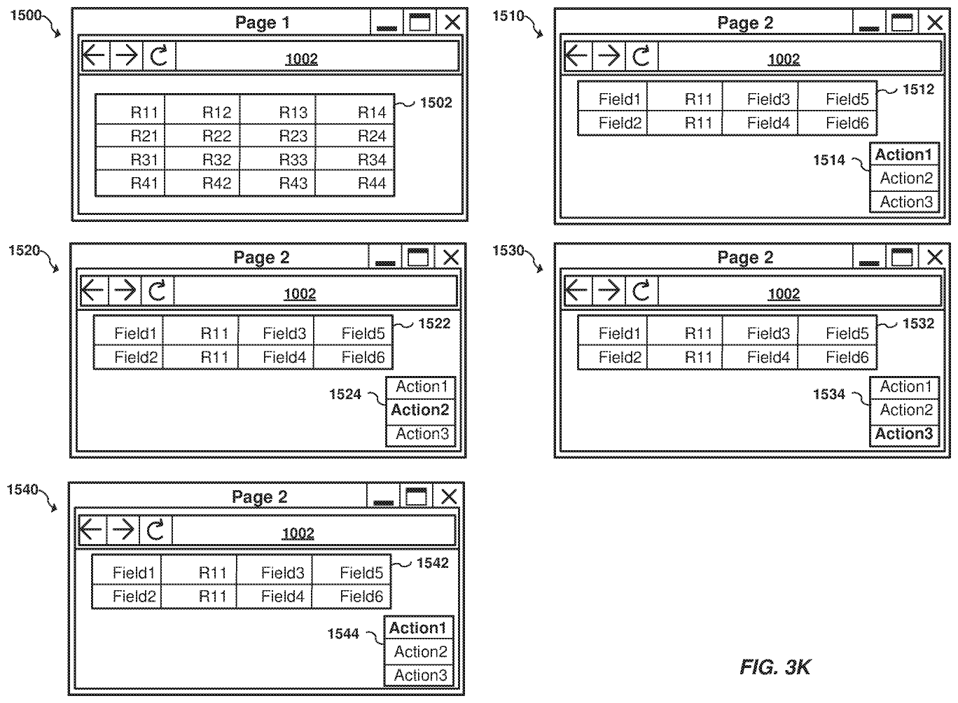

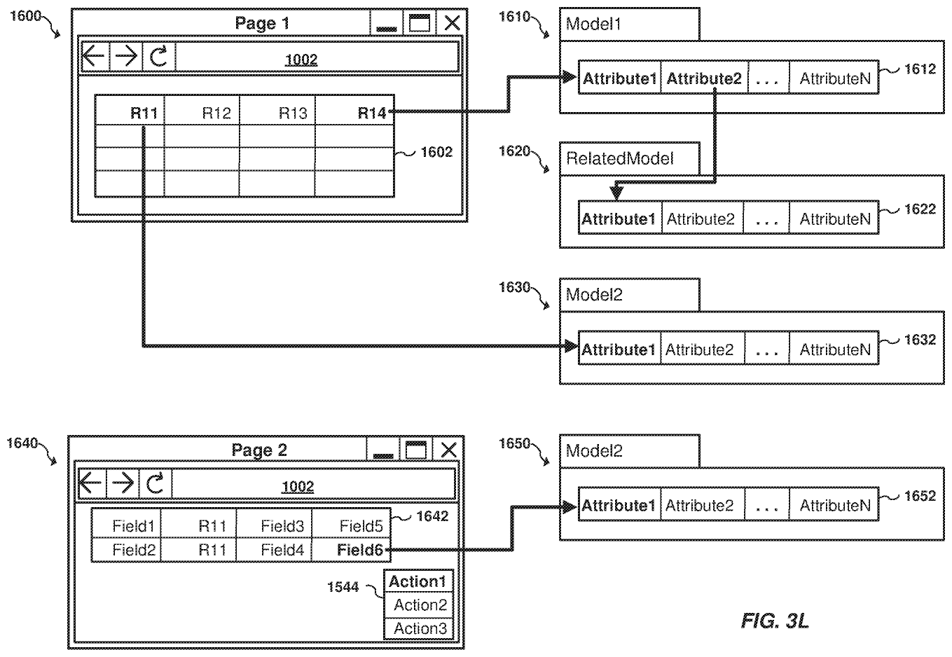

Referring to FIGS. 3A-3J, exemplary user interfaces of an exemplary computer-based system for improved processing in a value chain network in accordance with an embodiment of the present invention are shown. It is understood that other user interfaces are possible within the scope of the invention and that the graphical user interfaces shown are not intended to be limiting to the present invention. According to one embodiment, when a vendor 34a-34n and/or user 32a-32n, the vendor 34a-34n and/or user 32a-32n is presented with graphical user interfaces similar to the exemplary graphical user interfaces shown in FIGS. 3A-3J. The graphical user interfaces include business value opportunities shown in FIG. 3A. An exemplary listing of projected stockouts (high) is shown in FIGS. 3B-3G. Selecting any of the projected stockouts (high) entries displays additional information such as the exemplary information shown in FIGS. 3C-3G. Using these graphical user interfaces, a vendor 34a-34n and/or user 32a-32n may view and/or edit a particular projected stockout (high) entry.

FIG. 3A, identified as 1000, shows an exemplary list of opportunity types 1004. These include, without limitation, stockout, projected stockout, vendor stockout, inventory below minimum quantity, inventory above maximum quantity, projected inventory above maximum quantity, and projected inventory below minimum quantity. The opportunity types are grouped into different risk categories. According to one possible embodiment, these risk categories include, without limitation, high, medium and low categories. The total number of opportunities for each opportunity type is shown along with the number of opportunities in each risk category.

FIG. 3B, identified as 1025, shows an exemplary opportunity list view of the opportunities in a particular risk category 1026. In this example, the projected stockouts in the high risk category is shown. The opportunity list view includes, without limitation, the opportunity name, its expiration date, current status, and total value.

FIG. 3C, identified as 1050, shows an expanded detail view 1052 of the first opportunity shown in FIG. 3C. The expanded detail includes, without limitation, opportunity information, order information, and supplier information. The opportunity information includes, without limitation, a stockout date, number of days of supply and number of units on hand. The order information includes, without limitation, earliest order delivery date, target reorder number, order up to amount, and order lead time in days. The supplier information includes, without limitation, the supplying facility, primary supplier and alternate suppliers.

FIGS. 3D-3G, identified respectively as 1100, 1150, 1200 and 1250, show a communication thread 1102 provided by graphical user interfaces of the present invention. The communication thread 1102 includes, without limitation, a text area to enter a message, an attach button, and one or more communications 1104, 1152, 1202 and 1252.

FIG. 3H, identified as 1300, shows an activity stream associated with an opportunity, and FIG. 3I, identified as 1350, shows an attachment list associated with an opportunity. The initial summary and final summary are the before or after data values that capture the data required for calculations.

Referring to FIGS. 3K and 3L, exemplary user interfaces of an exemplary computer-based system for improved processing in a value chain network in accordance with another embodiment of the present invention are shown. However, it is understood that other user interfaces are possible within the scope of the invention and that the graphical user interfaces shown are not intended to be limiting to the present invention. According to this embodiment, a computer program monitors user actions and the sequence of web pages that one or more users have visited prior to taking any action. For actions that may be repeated over a period of time, the system attempts to learn any relationships and patterns between the user actions and the data. According to one possible implementation, these learned patterns are extracted as system defined action macros. The action macros may optionally be applied to future sets of relevant data that the system predicts will eventually result into set of actions that is the same as output of action macro. Action macros may be presented to the one or more users by any known means, including without limitation by means of a graphical user interface or the like. Action macros may be grouped by common actions wrapping large set of datasets relevant for a user to support decision making. Thereby, the user may avoid invoking multiple repeated actions over again and again, and instead use a single click. System recommended action macros may be monitored for their accuracy based on one or more system recommendations, and one or more actual planner actions. A high accuracy macro may be configured to be completely automated to avoid user interactions.

There can be multiple cases that impacts the decision-making process to determine the relationship between the data and the resulting actions. These include, without limitation, (i) a bounded scope, (ii) a bounded scope with dependencies, and (iii) an unbounded scope.

### Bounded Scope

In a bounded scope situation, the system determines a pattern in which a user navigates a navigation path inspecting all the data elements contained within the navigated web pages to learn any dependencies between the actions and the data elements contained within the navigated web pages. In a non-limiting example shown in FIG. 3K, let's assume a user typically follows a fixed navigation pattern of accessing web page 1 (1500), then web page 2 (1510, 1520, 1530, and 1540), and then chooses actions Action 1, Action 2 or Action 3 available on web page 2 (1510, 1520, 1530, and 1540). Let's also assume web page 1 (1500) consists of a tabular form (1502) with multiple rows and for each row, and that web page 2 (1510, 1520, 1530, and 1540) consists of information related to a corresponding row from web page 1 (1500). For rows 1 and 4 on web page 1 (1500), assume the user chooses Action 1 (1514), while for rows 2 and 3, the user chooses Action 2 (1524) and Action 3 (1534), respectively.

Assume that Action 1 chosen by user for R11 in web page 1 is completely dependent on the information available on web page 1 (1500), including R11, R12, R13 and R14, and web page 2 (1510, 1520, 1530, and 1540), including Field 1 R11, Field2 R11, Field 3, Field4, Field5 and Field6. Using a neural network, the system self-learns the rules of when to invoke Action 1, Action 2 or Action 3 by providing these past resulted output actions along with the set of all these input data from web page 1 (1500) and web page 2 (1510, 1520, 1530, and 1540). According to this example, if Action 1 depends only on web page 1 (1500) R11 and R12, and web page 2 (1510, 1520, 1530, and 1540) Field1 R11 and Field2 R11, then the action macro for Action 1 may be represented as:

Action1=Fn(Page1{R11, R12}, Page2 {field1 R11, field2 R11})

For simplicity reasons, the example described in FIG. 3K only applies to two pages containing four rows of data. However, it is understood that in real-world applications, with huge amounts of data, the data may be represented in a more complex manner. For instance, there may be a large number of rows on each web page and the navigation tree can be of nth degree. In a scenario where the user navigates from web page 1 (1500), to web page 2 (1510, 1520, 1530, and 1540), to web page 3 (not shown), and then to web page 2 (1510, 1520, 1530, and 1540) to invoke the required action. This scenario is also considered as bounded scope if the values on web page 3 (not shown) drives decision making to support an action invoked on web page 2 (1510, 1520, 1530, and 1540). In a client-server application, the input data set to derive the decision-making rules is union of both the client and server-side data.

Bounded Scope with Dependencies

In a bounded scope with dependencies situation, the system determines a pattern in which the user is following a navigation path that does not contain all the data elements within the navigated web pages, to learn the dependency between the actions and the visited data elements. In the non-limiting example shown in FIG. 3L, let's assume the dependent elements for all the bounded scope elements are pulled using entity relationship modelling of these bounded fields. According to this embodiment, the information required to learn the relationship can be derived using the same approach as described for the bounded scope above, but with extended dataset containing depended dataset. As shown, the data for R14 of web page 1 (1600) is derived from Attribute 1 and Attribute 2 of Model 1 (1610), and Attribute 1 of RelatedModel (1620). The data for R11 of web page 1 (1600) is derived from Attribute 1 of Model 2 (1630). The data for Field 6 of web page 2 (1640) is derived from Attribute 1 of Model 2 (1650). In a client-server application, the input data set to derive the decision-making rules is union of both the client and server-side data.

### Unbounded Scope

In an unbounded scope situation, the system determines a pattern in which the user is following a navigation path that does not contain all the data elements within the navigated web pages and cannot learn the decision-making rules, even after pulling the dependent dataset. In this situation, the scope to create input dataset could be extended by using one of the following approaches: (i) an extended set by pulling in elements from models and attributes for the user-role permission; (ii) elements from enterprise level permissions; or (iii) elements from value chain permissions. In a client-server application, the input data set to derive the decision-making rules is union of both the client and server-side data.

### Macro Derivation

The system captures the sequence of web pages the user is visiting and the data that is visible to user. The system captures the actions that are taken by user. The sequence of these search and data is marked as input. The action is captured as output. During a learning phase, the input is passed to a neural network which deciphers based on the configured rules. If the rules provides the desired output which matches the actual output, then the input path and elements are captured as a macro. If the output differs from its expectation, then input is extended to pull in depended scope elements and the process is repeated again until the desired output is determined. If the desired output is not returned, the input scope is extended for role→enterprise→VC elements.

The present invention may utilize or more computer applications. As used herein, a “computer application” is a computer executable software application of any type that executes processing instructions on a computer or embedded in a processor, and an “application” or “application project” are the files, objects, structures, database resources and other resources used in integrating a computer application into a software platform.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

This invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, portions of the invention may be embodied as a method, device, or computer program product. Accordingly, portions of the present invention may take the form of an entirely hardware embodiment or an embodiment combining software and hardware aspects all generally referred to as a “circuit” or “module.”

The present invention includes a computer program product which may be hosted on a computer-usable storage medium having computer-usable program code embodied in the medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Computer program code for carrying out operations of the present invention may be written in any programming language including without limitation, object oriented programming languages such as Java®, Smalltalk, C# or C++, conventional procedural programming languages such as the “C” programming language, visually oriented programming environments such as VisualBasic, and the like.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program product embodied on a non-transitory computer readable medium for providing automated actions and content to one or more web pages relating to the management of a value chain network, wherein the value chain network includes a shared database on a computer over a network, wherein the computer program is implemented by one or more processors executing processor instructions, the computer program product comprising:
a first computer code for identifying an event in a value chain network;
a second computer code for calculating a target value and a projected lost value in relation to an established target, wherein the target value is the anticipated value if the event in the value chain network had not occurred and the projected lost value is the anticipated lost value due to the event in the value chain network;
a third computer code for calculating a potential impact on a related performance target associated with the event;
a fourth computer code for receiving or prescribing one or more actions to resolve the event in the value chain network from one or more remote computers operated by respective one or more users;
a fifth computer code for calculating a recovered value, wherein the recovered value is the anticipated recovered value less the cost associated with each of the one or more actions to resolve the event in the value chain; and
a sixth computer code for calculating the difference between the target value and the recovered value;
a seventh computer code for comparing the difference between the target value and the recovered value and historical differences stored in a database;
an eighth computer code for storing the difference between the target value and the recovered value when the difference is less the respective historical differences stored in the database;
a ninth computer code for retrieving the respective historical differences stored in the database; and
a tenth computer code for transmitting one or more web pages containing the target value, recovered value and respective historical differences to a computer display.

2. The computer program product of claim 1, wherein the event in a value chain network comprises a projected stockout.

3. The computer program product of claim 1, wherein the order includes one or more financial transactions, and wherein the computer program product further comprises a sixth computer code for providing initiation and confirmation of the one or more financial transactions.

4. A system for providing automated actions and content to one or more web pages relating to the management of a value chain network, the system comprising:
a plurality of remote computers;
a central server;
a network interface in communication with the central server and the plurality of remote computers over a network, the network interface being configured to receive one or more transactions via the network, wherein the value chain network includes a plurality of local networks having shared access to two or more shared databases on a service provider computer over a network via a database router module;
a shared database in communication with the central server;
wherein the central server is configured to:
identify an event in a value chain network;
calculate a target value and a projected lost value, wherein the target value is the anticipated value if the event in the value chain network had not occurred and the projected lost value is the anticipated lost value due to the event in the value chain network;
calculate a potential impact on a related performance target associated with the event;
receive or prescribe one or more actions to resolve the event in the value chain network from one or more remote computers operated by respective one or more users;
calculate a recovered value, wherein the recovered value is the anticipated recovered value less the cost associated with each of the one or more actions to resolve the event in the value chain; and
calculate the difference between the target value and the recovered value;
compare the difference between the target value and the recovered value and historical differences stored in a database;
store the difference between the target value and the recovered value when the difference is less the respective historical differences stored in the database;
retrieve the respective historical differences stored in the database; and
transmit one or more web pages containing the target value, recovered value and respective historical differences to a computer display.

5. A computer program product embodied on a non-transitory computer readable medium for providing automated actions and content to one or more web pages relating to the management of a value chain network, wherein the value chain network includes a shared database on a computer over a network, wherein the computer program is implemented by one or more processors executing processor instructions, the computer program product comprising:
a first computer code for identifying and capturing a macro derivation having a set of activities in a value chain network, wherein the set of activities includes one or more user clicks on one or more web pages;
a second computer code for calculating an accuracy value for the macro derivation;
a third computer code for storing the macro derivation and accuracy value for the macro derivation;
a fourth computer code for retrieving a macro derivation recommendation for the one or more web pages based on similarities between the currently required macro derivation and the stored macro derivation and the accuracy value of the macro derivation recommendation;
a fifth computer code for providing a macro derivation recommendation to the user, wherein the macro derivation recommendation may be accepted or rejected by the user, wherein calculating the accuracy value for the macro derivation recommendation includes refining accuracy value positively or negatively based on the respective acceptance or rejection of the macro derivation recommendation;
a sixth computer code for storing the refined accuracy value for the macro derivation; and
a seventh computer code for executing the macro derivation recommendation upon acceptance by the user on one or more web pages to a computer display.

6. The computer program product of claim 5, wherein the one or more web pages include a plurality of data elements, and wherein the computer program product further comprising an eighth computer code for determining a pattern between the set of activities and the plurality of data elements.
